(19) United States
(12) Patent Application Publication
(10) Pub. No.: US 2002/0145873 A1
(43) Pub. Date: Oct. 10, 2002

(54) Ribbon light assembly

(76) Inventor: Najeh Rahman, Harriman, NY (US)

Correspondence Address: Neal L. Rosenberg, Esq., AMSTER, ROTHSTEIN & EBENSTEIN, 90 Park Avenue, New York, NY, 10016, US

(21) Appl. No.: 09/828,766

(22) Filed: Apr. 9, 2001

(51) Int. Cl. F21S 13/14

(52) U.S. Cl. 362/252; 362/249; 362/250; 362/391

(57) ABSTRACT

A ribbon light assembly has in combination a substrate defining a matrix of structural elements and spaced apart apertures there through defined by the matrix, and at least one light string releasably intertwined with substrate. Each light string is formed of a plurality of lamp sockets and a plurality of wires connecting the lamp sockets. Each of the lamp sockets is substantially disposed on one substrate surface, and each of the wires is substantially disposed on an opposite surface. Each lamp socket defines a securing clasp extending from the one substrate surface through a respective one of the apertures and releasably receiving one of the wires on the opposite substrate surface, thereby to releasably maintain the lamp sockets in a fixed pattern on the substrate. The securing clasps receives only the wires and not the structural elements therein.

### BACKGROUND OF THE INVENTION

The present invention relates to a ribbon light assembly, and more particularly to such an assembly comprising a substrate and at least one light string releasably intertwined with the substrate.

It is well known in the prior art to provide a ribbon light assembly comprising in combination a substrate and at least one light string releasably intertwined with the substrate. The substrate comprises a matrix of structural elements and a plurality of spaced apart apertures there through defined by the matrix. Each light string comprises a plurality of lamp sockets and a plurality of wires connecting the lamp sockets. Each of the lamp sockets is disposed on one major surface of the substrate and defines securing means which releasably receives at least one of the structural elements therein, thereby to releasably maintain the lamp sockets in a fixed pattern on the substrate.

The known ribbon light assemblies have not proven to be entirely satisfactory. Because the securing means must be configured and dimensioned to releasably receive therein at least one of the structural elements of the substrate, and since these substrates structural elements may be of substantial thickness, the securing means is necessarily of a relatively large size such that it assumes untoward prominence rather than merely receding into the background so that the appearance of the assembly properly emphasizes the lamp sockets and lamps alone.

Further, the light string must be manufactured with an eye towards its application on a particular substrate to ensure that the securing means of the light sockets are appropriately sized to releasably receive the substrate structural elements.

Accordingly, it is an object of the present invention to provide a ribbon light assembly wherein the securing means of the lamp sockets of the light string may be configured and dimensioned without regard to the size of the substrate structural elements.

Another object is to provide such an assembly wherein the light string is capable of being releasably maintained on a variety of different substrates without regard to the dimensions of the structural elements thereof.

A further object is to provide such an assembly which is inexpensive and simple to manufacture, use and maintain and lends itself to easy compact storage.

### SUMMARY OF THE INVENTION

It has now been found that the above related objects of the present invention are obtained in a ribbon light assembly comprising in combination a substrate and at least one light string releasably intertwined with the substrate. The substrate defines a matrix of structural elements and a plurality of spaced apart apertures there through defined by the matrix. Each light string is formed of a plurality of lamp sockets and a plurality of wires connecting the lamp sockets, each of the lamp sockets being substantially disposed on one surface of the substrate, and each of the wires being substantially disposed on an opposite surface of the substrate. Each lamp socket defines securing means extending from the one substrate surface through a respective one of the apertures and releasably receiving therein one of the wires on the opposite substrate surface, thereby to releasably maintain the lamp sockets in a fixed pattern on the substrate. The securing means receive only the wires and not the structural elements therein.

In a preferred embodiment the wires extend between opposite substrate surfaces through a first set of the apertures, and the securing means extend between the opposite substrate surfaces through a second set of the apertures, the first and second sets of apertures being mutually exclusive.

Preferably the substrate is formed of a material enabling rolling or folding of the substrate, and the lamp sockets have a longitudinal length greater than the corresponding lengths of the substrate apertures.

The structural elements are preferably disposed in generally horizontal rows and generally vertical columns to define the matrix. There are preferably a plurality of the light strings, each light string being disposed on the substrate in a respective substantially parallel row corresponding to a row of the structural elements or in a respective substantially parallel column corresponding to a column of the structural elements.

### BRIEF DESCRIPTION OF THE DRAWING

The above related objects, features and advantages of the present invention will be more fully understood by reference to the following detailed description of the presently preferred, albeit illustrative, embodiments of the present invention when taken in conjunction with the accompanying drawing wherein;

FIG. 1 is a fragmentary front elevational schematic view of a ribbon light assembly according to the present invention, illustrating the wires and structural elements without thickness;

FIG. 2 is a fragmentary front elevational view, to an enlarged scale, of one light string of the assembly and its associated wires on a substrate;

FIG. 3 is a fragmentary top plan view, to an enlarged scale, of the assembly; and

FIG. 4 is a sectional view taken along the line 4-4 of FIG. 3.

### DETAILED DESCRIPTION OF THE PREFERRED EMBODIMENTS

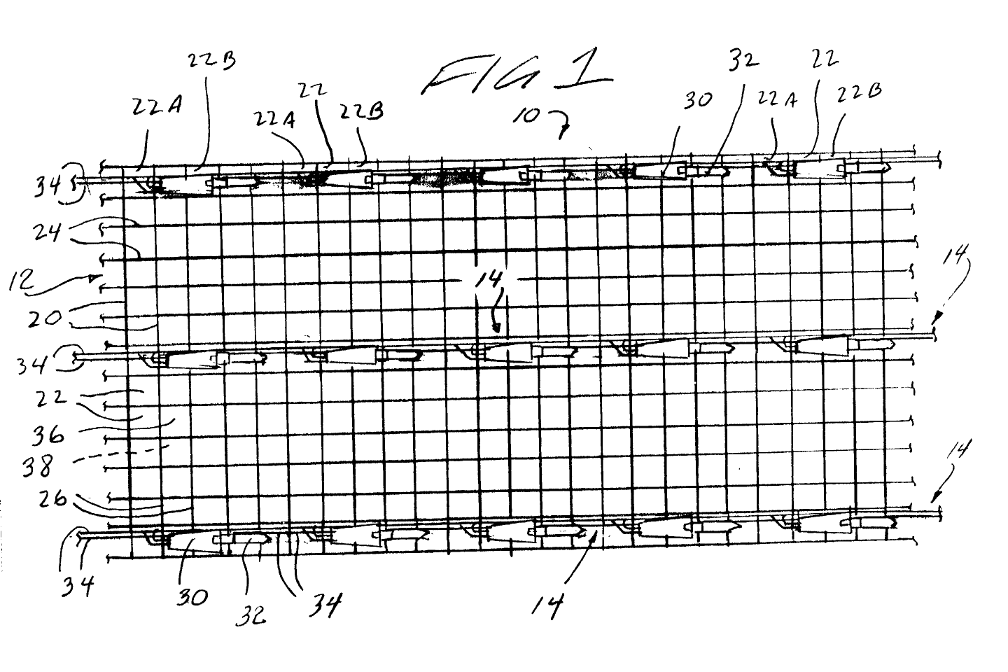

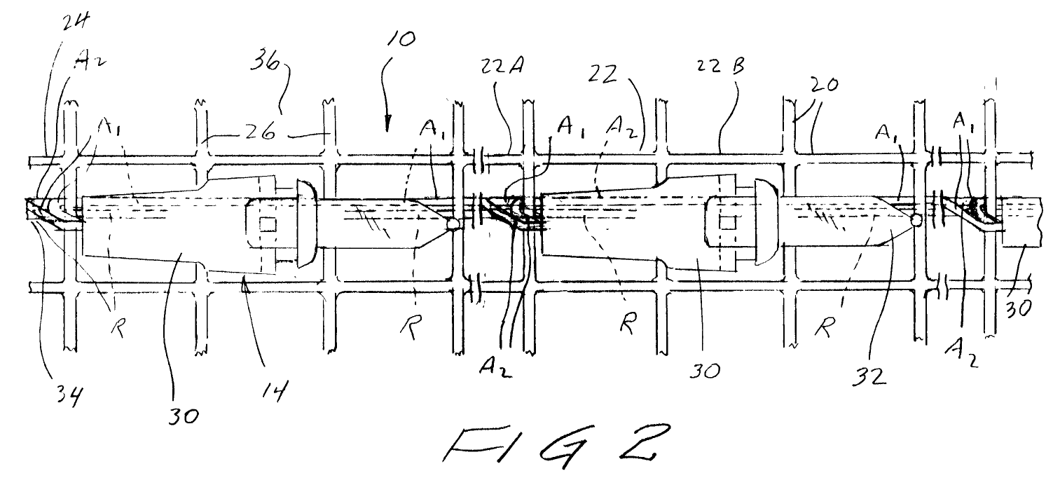

Referring now to the drawing and in particular to FIGS. 1 and 2 thereof, therein illustrated is a ribbon light assembly according to the present invention, generally designated by the reference numeral 10. The assembly 10 comprises in combination a substrate, generally designated 12, and at least one light string, generally designated 14 (three parallel light strings 14 being illustrated in FIG. 1).

The substrate 12 defines a matrix of structural elements 20 and a plurality of spaced apart apertures 22 there through defined by the matrix. Typically, the structural elements 20 are disposed in generally horizontal rows 24 and generally vertical columns 26, thereby to define the matrix. The substrate 12 is preferably formed of a material having sufficient rigidity to support the one or several light strings 14 secured thereto, thereby to enable the assembly 10 to be conveniently hung or mounted. In other words, the weight of the light strings 14 secured to the substrate 12 should not cause deformation of the substrate structural elements 20. On the other hand, the substrate 12 is preferably formed of a material flexible enough to enable forcible folding or rolling of the substrate 12 (either with the light strings 14 removed therefrom or still secured thereto) into a more compact storage orientation when not in use. Even if it is not intended to roll or fold the substrate 12, the substrate 12 must have sufficient flexibility to allow it to conform to the contours of the structure on which it will be hung—for example, a chimney, roof, fireplace mantel, or the like.

Each light string 14 is formed of a plurality of lamp sockets 30 (including lamps 32) and a plurality of electrical wires 34 physically and electrically connecting the lamp sockets 30 of a given light string 14 in series. The lamps 32 of the several sockets 30 of a given light string 14 may be electrically connected in parallel so that the nonfunctioning of a single lamp in a light string does not affect the other lamps in the light string. This is known in the light string art as a “series-parallel” connection.

In a simple embodiment of the present invention wherein all of the lamp sockets 30 (including lamps 32) of a given light string 14 are either on or off simultaneously, the plurality of electrical wires 34 may physically and electrically connect all of the lamp sockets 30 in the light string 14 in series using only a single active wire and a single return wire. The active wire from the plug enters one lamp socket and then leaves that lamp socket and enters the next lamp socket in the series, and so on. At the end of the light string the active wire is connected to the return wire which goes back to the plug. If desired, a flasher bulb may be introduced into the circuit formed by the active wire and return wire so that all the lamps of the light string will flash on and off as a unit.

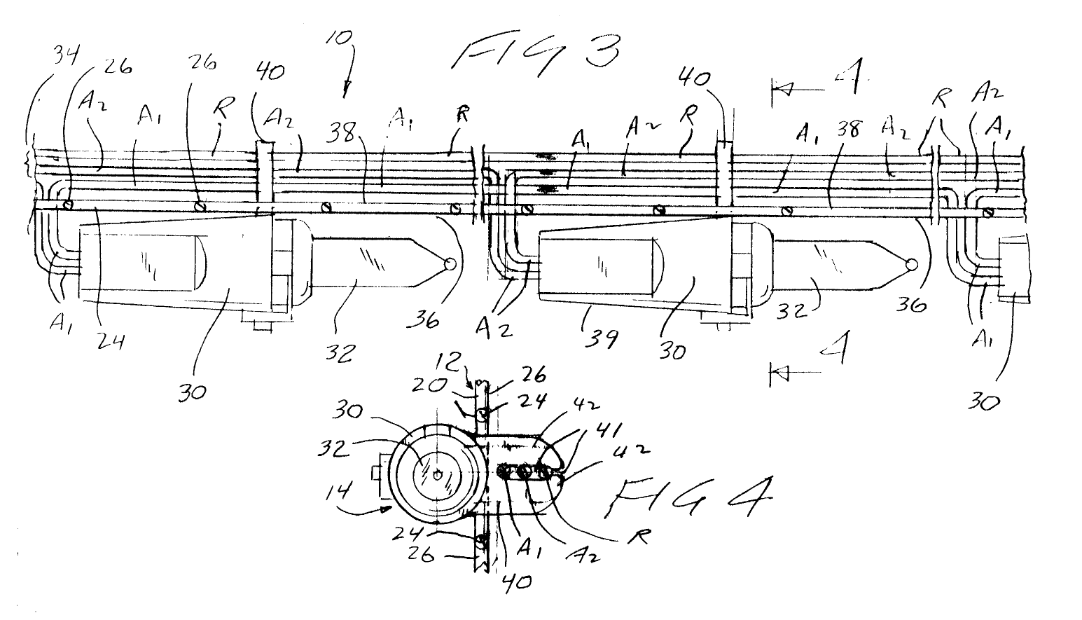

For more interesting effects the wires 34 may organize the lamp sockets 30 into a plurality of distinct sets which may flash on and off at different times and even at different intervals, but in this instance more than two wires are required. For example, referring now to FIGS. 2 and 3 in particular, the various lamp sockets 30 of a given light string 14 may be divided into two sets consisting of alternate lamp sockets 30. One set is connected to active wire A₁ and the other set is connected to active wire A₂. Both sets are connected to a common return wire R. Thus, for example, active wire A₁ enters into an odd-numbered lamp socket 30 and, via its connection with the lamp 32 thereof, leaves that odd-numbered lamp socket 30 and passes onto the next odd-numbered lamp socket 30 (the first odd-numbered socket being illustrated at the left of FIGS. 2 and 3 and the second odd-numbered socket being illustrated fragmentarily at the right of FIGS. 2 and 3). Similarly, active wire A₂ enters into an even numbered lamp socket 30 and, via its connection with the lamp 32 thereof, leaves that even-numbered lamp socket 30 and passes on to the next even-numbered lamp socket 30 (the first even-numbered lamp socket being illustrated in the middle of FIGS. 2 & 3 and the second even-numbered lamp socket not being illustrated in FIGS. 2 & 3). The active wires A₁ and A₂ and the common return wire R are connected electrically to a common plug (not shown) either directly or through a conventional controller (not shown) which actuates the active wires A₁, A₂ in an appropriate sequence. Clearly the principles of the present invention apply equally where the lamp sockets of a given light string are organized into a greater number of sets for more intricate effects.

Referring now in particular to FIG. 3, each of the lamp sockets 30 is substantially disposed of on one major surface 36 of the substrate 12 (hereinafter the “front”), and each of the wires 34 is substantially disposed on an opposite major surface 38 of the substrate 12 (hereinafter the “back”). Clearly the wires 34 cannot be exclusively disposed on the back 38 because, adjacent to the base of each lamp socket 30, at least one wire 34 must briefly switch over to front 36, via a respective one of the apertures 22, so that the wire 34 may enter and leave the socket 30, thereby to energize the lamp 32. Clearly the lamp sockets 30 cannot be exclusively disposed on the front 36 because each lamp socket 30 defines not only a generally cylindrical torso 39, but also a securing means 40 extending from the front 36, via a respective one of the apertures 22, to the back 38 so that it and may releasably receive at least one of the wires 34 disposed on the back 38 (and, as illustrated, three wires 34). Thus, the securing means 40 extend to the back 38 in order to receive the wires 34, thereby to releasably maintain both the lamp sockets 30 and wires 34 in a fixed pattern on opposite surfaces of the substrate 12.

The securing means 40 (best seen in FIGS. 3 and 4) is illustrated as an outwardly projecting split lug which defines there through a slot 41 (best seen in FIG. 4) configured and dimensioned to receive at least one of the wires 34, and optionally a plurality of such wires 34. Preferably the securing means 40 is of a unitary, one-piece, integral construction with the remainder of the lamp socket 30, and is formed therewith in a single plastic or rubber molding operation. While the torso 39 of the socket 30 is substantially rigid, the slot-defining legs 42 of lug 40 may be configured and dimensioned to enable a certain resiliency, thereby to enable forcible passage of a wire 34 into or out of the slot 41. Those familiar with the miniature lamp socket art will appreciate that securing means 40 may be provided in a variety of different configurations, some configurations requiring the securing means 40 to be resilient in nature and other configurations requiring it to be rigid in nature.

The three wires A₁ , A₂, and R are illustrated in FIGS. 3 and 4 as being neatly held in a narrow slot 41 in single file (transverse to the plane of the substrate 12), thereby to minimize viewing of the several wires 34 from the front of the assembly 10. However, a wider slot 41 may be used to accommodate two or even three of the wires abreast, as illustrated for expository purposes in FIGS. 1 and 2 (where the wires A₁, and A₂ are in single file—one in front of the other—while wire R is to one side thereof).

In the preferred embodiment illustrated, the wires 34 extend between opposite substrate surfaces 38, 36 through a first set 22A of the apertures 22, while the securing means 40 extend between opposite substrate surfaces 36, 38 through a second set 22B of the apertures 22, the first and second sets 22A, 22B of apertures 22 being mutually exclusive.

To ensure that the wires 34 on the substrate back 38 do not pull the lamp socket torsos 39 through substrate apertures 32 (via the securing means 40), the lamp socket torsos 39 are preferably dimensioned such that, when they extend parallel to the substrate front 36, they cannot pass through the substrate apertures 22. This is readily achieved by providing the lamp socket torsos 39 with a longitudinal length greater than the corresponding length of the substrate apertures 22. This arrangement has the advantage of preventing the structural elements 20 defining the aperture 22 from pressing against and possibly damaging the lamps 32.

Where, as illustrated, a plurality of the light strings 14 are mounted on a given substrate 12, each light string 14 may be disposed in a respective substantially parallel row corresponding to a row 24 of the structural elements 20 or in a respective substantially parallel column corresponding a column 26 of the structural elements 20. Either of these arrangements enables achievement of a desirable aesthetic “ribbon” appearance. For a particular application some light strings may be disposed in rows and some in columns, and indeed some light strings may be disposed diagonally from one corner to another. In brief, the light strings may be arranged in a wide variety of arcuate, circular, polygonal, or artistic configurations as desired.

If the light strings 14 are separated from the substrate 12 for storage purposes, the securing means 40 are preferably re-engaged with the wires 34 to assist in maintaining an appropriate alignment of the lamp sockets 30 with the axis of the wires 34 during storage. However, this is not essential.

An assembly according to the present invention may be created using either a pre-existing substrate 12 or a pre-existing light string 14 and assembling them together as taught herein, as opposed to buying a pre-formed assembly 10 according to the present invention.

A critical feature of the present invention is that the securing means 40 receives therein only the wires 34 and not the structural elements 20. Accordingly, as long as the securing means 40 of a given light string 14 are configured and dimensioned to releasably receive the wires 34 of that light string, the light string may be mounted on any substrate 12 defining a matrix and apertures without regard to the dimensions (i.e. thickness) of the structural elements 20 of that substrate.

Depending upon the relative sizes of the lamp sockets 30 (and in particular the securing means 40 and slots thereof) and the individual wires 34, it may be possible to secure each lamp socket to more than one wire via the securing means. A particularly neat and orderly arrangement is obtained where the lamp socket securing means can grip all of the wires in a give light string. However, the principles of the present invention are applicable to situations in which the securing means of a lamp socket can accommodate therewithin fewer than all of the wires in a light string.

To summarize, the present invention provides a ribbon light assembly wherein the securing means of the lamp sockets of the light string may be configured and dimensioned without regard to the size of the substrate structural elements so that a given light string is capable of being releasably maintained on a variety of different substrates without regard to the dimensions of the structural elements thereof. The assembly is inexpensive and simple to manufacture, use and maintain, and lends itself to easy compact storage.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

I claim:

1. A ribbon light assembly comprising in combination:
(A) a substrate defining a matrix of structural elements and a plurality of spaced apart apertures there through defined by said matrix;
(B) at least one light string releasably intertwined with said substrate, each said light string being formed of a plurality of lamp sockets and a plurality of wires connecting said lamp sockets, each of said lamp sockets being substantially disposed on one surface of said substrate, and each of said wires being substantially disposed on an opposite surface of said substrate;
each said lamp socket defining securing means extending from said one substrate surface through a respective one of said apertures and releasably receiving one of said wires on said opposite substrate surface, thereby to releasably maintain said lamp sockets in a fixed pattern on said substrate, said securing means receiving only said wires and not said structural elements therein.

2. The assembly of claim 1 wherein said lamp sockets have a longitudinal length greater than the corresponding lengths of said apertures.

3. The assembly of claim 1 wherein said wires extend between opposite substrate surfaces through a first set of said apertures, and said securing means extend between said opposite substrate surfaces through a second set of said apertures.

4. The assembly of claim 3 wherein said first and second sets of apertures are mutually exclusive.

5. The assembly of claim 1 wherein said substrate is formed of a material enabling rolling or folding of said substrate.

6. The assembly of claim 1 wherein said structural elements are disposed in generally horizontal rows and generally vertical columns to define said matrix.

7. The assembly of claim 1 wherein there are a plurality of said light strings, each said light string being disposed on said substrate in a respective substantially parallel row corresponding to a row of said structural elements.

8. The assembly of claim 1 wherein there are a plurality of said light strings, each said light string being disposed on said substrate in a respective substantially parallel column corresponding to a column of said structural elements.

9. A ribbon light assembly comprising in combination:
(A) a substrate defining a matrix of structural elements and spaced apart apertures there through defined by said matrix;
(B) at least one light string releasably intertwined with said substrate, each said light string being formed of a plurality of lamp sockets and a plurality of wires connecting said lamp sockets, said lamp sockets having a longitudinal length greater than the corresponding lengths of said apertures, each of said lamp sockets being substantially disposed on one surface of said substrate, and each of said wires being substantially disposed on an opposite surface of said substrate;
each said lamp socket defining securing means extending from said one substrate surface through a respective one of said apertures and releasably receiving one of said wires on said opposite substrate surface, thereby to releasably maintain said lamp sockets in a fixed pattern on said substrate, said securing means receiving only said wires and not said structural elements therein;
said wires extending between opposite substrate surfaces through a first set of said apertures, and said securing means extend between said opposite substrate surfaces through a second set of said apertures, said first and second sets of apertures being mutually exclusive.

10. The assembly of claim 9 wherein said substrate is formed of a material enabling rolling or folding of said substrate.

11. The assembly of claim 9 wherein said structural elements are disposed in generally horizontal rows and generally vertical columns to define said matrix, there are a plurality of said light strings, and each said light string is disposed on said substrate in a respective substantially parallel row corresponding to a row of said structural elements.
